(19) United States
(12) Patent Application Publication
(10) Pub. No.: US 2018/0105017 A1
(43) Pub. Date: Apr. 19, 2018

(54) HEATER DEVICE

(71) Applicant: DENSO CORPORATION, Kariya-city, Aichi-pref. (JP)

(72) Inventors: Hideki SEKI, Kariya-city (JP); Hideaki KAKO, Kariya-city (JP); Kimitake ISHIKAWA, Kariya-city (JP); Hiroyasu OIDE, Kariya-city (JP)

(21) Appl. No.: 15/562,812

(22) PCT Filed: Feb. 29, 2016
(86) PCT No.: PCT/JP2016/056125

§ 371 Date: Sep. 28, 2017

(30) Foreign Application Priority Data
Apr. 7, 2015 (JP) 2015-078674

(51) Int. Cl. B60H 1/22; H05B 3/10; H05B 3/34

(52) U.S. Cl. CPC B60H 1/2215; H05B 3/10; H05B 2203/032; B60H 2001/2256; B60H 2001/2287; H05B 3/34

(57) ABSTRACT

A heater device includes a heat generating body and a surface layer portion. The heat generating body includes a heating surface and radiates heat from the heating surface. The surface layer portion is stacked over the heating surface and is heated by the heat generating body. Furthermore, the surface layer portion changes color according to a temperature of the surface layer portion.

### CROSS REFERENCE TO RELATED APPLICATION

This application is based on and incorporates herein by reference Japanese Patent Application No. 2015-78674 filed on Apr. 7, 2015.

### TECHNICAL FIELD

The present disclosure relates to a heater device that radiates heat.

### BACKGROUND ART

Previously, for example, a radiation panel structure recited in the patent literature 1 is known as this type of heater device. The radiation panel structure, which is recited in the patent literature 1, adjusts the temperature of a room through radiation of heat. This radiation panel structure includes a first portion, which has a first color, and a second portion, which has a different color that is different from the first color. The amount of thermal radiation is influenced by a color of a radiation surface. Therefore, when the colors are different, the amounts of thermal radiation are different from each other. Thereby, at the radiation panel structure, the amount of thermal radiation can be adjusted through a combination of the different colors.

### CITATION LIST

### Patent Literature

PATENT LITERATURE 1: JP2004-271057A

### SUMMARY OF INVENTION

However, in the heater device of the patent literature 1, which is the radiation panel structure, a temperature state of the heater device cannot be notified to a subject person who is heated with the heater device through an appearance of the heater device after actuation of the heater device. The above points are found as a result of detailed study conducted by the inventors of the present application.

The present disclosure is made in view of the above points, and it is an objective of the present disclosure to notify a temperature state of the heater device through the appearance of the heater device.

Lately, there is an article, such as a toy, which changes color when the article is immersed in warm water in a bath. This is caused by action of thermal ink. For example, the action of the thermal ink is as follows. That is, in a case where the thermal ink is applied as a paint to a surface of the toy, or a case where a resin material of the toy contains the thermal ink, the toy changes color when the toy is heated to a temperature range, at which the thermal ink changes color, or higher. The inventors of the present disclosure have focused on the phenomenon of the color change of the substance according to the temperature of the substance.

In view of the above matter, in order to achieve the objective of the present disclosure, according to one aspect of the present disclosure, there is provided a heater device including:

a heat generating body that includes a heating surface and radiates heat from the heating surface; and

a surface layer portion that is stacked over the heating surface and is to be heated by the heat generating body,

wherein the surface layer portion changes color depending on a temperature of the surface layer portion.

According to the above disclosure, the surface layer portion is stacked over the heating surface of the heat generating body and is heated by the heat of the heat generating body, and the surface layer portion changes color according to the temperature of the surface layer portion. Thus, it is possible to notify the temperature state of the heater device to, for example, the subject person who is warmed with the heater device through the appearance of the heater device.

### BRIEF DESCRIPTION OF DRAWINGS

FIG. 1 is a diagram showing a positional relationship between heater devices and an occupant (a driver) according to a first embodiment.

FIG. 2 is an exploded perspective view schematically showing a structure of the heater device according to the first embodiment.

FIG. 3 is a cross sectional view of the heater device, which is cut in a thickness direction of the heater device according to the first embodiment.

FIG. 4 is a schematic diagram showing a relationship between colors of first and second color variable layers and a temperature of a surface layer portion at the heater device of the first embodiment.

FIG. 5 is an exploded perspective view of the heater device of the first embodiment, showing colors of the surface layer portion at a non-operating temperature range of a heat generating body, i.e., a non-operating temperature range of the heater device.

FIG. 6 is an exploded perspective view of the heater device of the first embodiment, showing colors of the surface layer portion at a normal operating temperature range (e.g., 60 to 120 degrees Celsius) of the heat generating body.

FIG. 7 is an exploded perspective view of the heater device of the first embodiment, showing colors of the surface layer portion at a time of generating an abnormal high temperature (e.g., higher than 120 degrees Celsius), at which the heat generating body partially becomes a high temperature beyond the normal operating temperature range.

FIG. 8 is an exploded perspective view of the heater device of the first embodiment, showing colors of the surface layer portion in a case where the occupant contacts an occupant side surface of the heater device when the temperature of the heat generating body is in the normal operating temperature range.

FIG. 9 is a schematic diagram, which corresponds to FIG. 4 and shows a relationship between a color of each color variable layer of the surface layer portion and a temperature of the surface layer portion at a heater device of a second embodiment.

FIG. 10 is a cross sectional view of the heater device, which corresponds to FIG. 3 of the first embodiment and is cut in a thickness direction of the heater device in a modification of the first embodiment.

### DESCRIPTION OF EMBODIMENTS

Hereinafter, embodiments of the present disclosure will be described with reference to the drawings. In the following embodiments, portions, which are identical to each other or equivalent to each other, will be indicated by the same reference signs in the drawings.

### First Embodiment

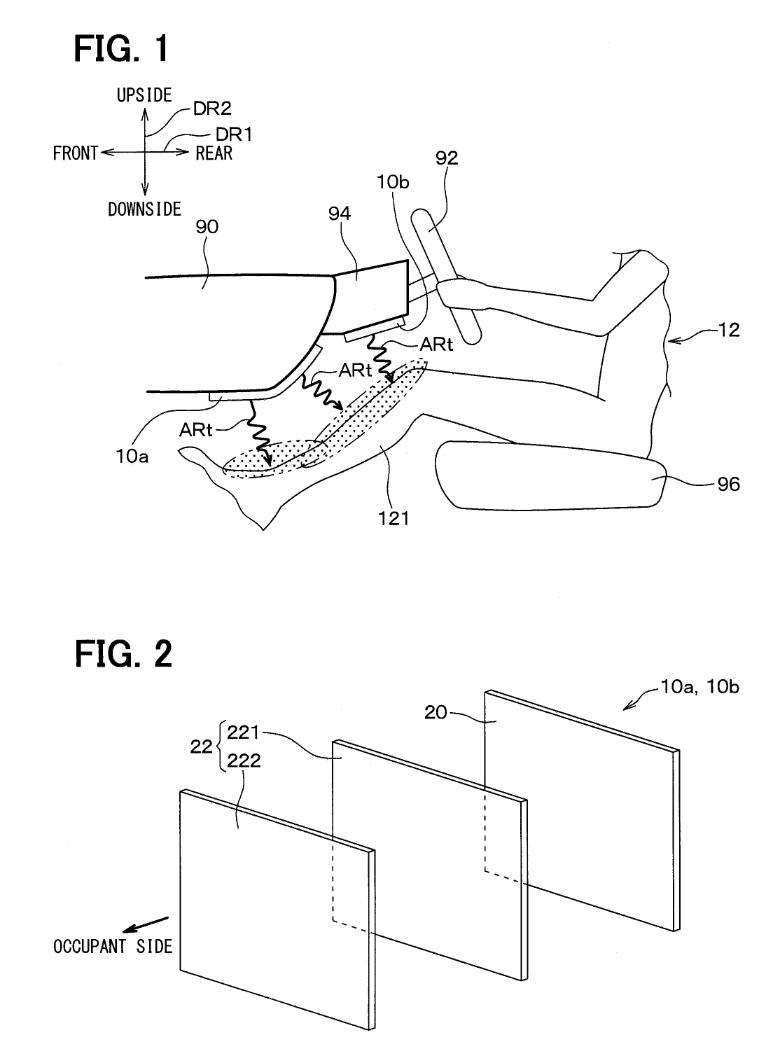

FIG. 1 is a diagram showing a positional relationship between heater devices 10a, 10b and an occupant (a driver) 12 according to the present embodiment. Each of arrows DR1, DR2 indicates corresponding direction of a vehicle, at which the heater devices 10a, 10b are installed. The double sided arrow DR1 shown in FIG. 1 indicates a vehicle front-to-rear direction DR1, and the double sided arrow DR2 shown in FIG. 1 indicates a vehicle up-to-down direction DR2.

As shown in FIG. 1, the number of the heater devices 10a, 10b is two, and a first heater device 10a among these two heater devices 10a, 10b is installed to a lower portion of an instrument panel 90. A second heater device 10b is installed to a lower portion of a steering column 94, which projects from the instrument panel 90 toward a vehicle rear side and supports a steering wheel 92. Each of the heater devices 10a, 10b is an electric heater that generates heat upon energization thereof.

The heater device 10a, 10b radiates heat downward and is opposed to legs 121 of the occupant 12 (i.e., the driver 12) who seats on a driver seat 96 and is in a driving position for driving the vehicle. The heater device 10a, 10b radiates the heat in, for example, a direction normal to a surface of the heater device 10a, 10b.

Each of the heater devices 10a, 10b is installable in a state where the heater device 10a, 10b is curved. As a matter of fact, the first heater device 10a is installed in the state where the first heater device 10a is curved along a curved surface of the instrument panel 90. The heater device 10a, 10b is a radiation heater device and radiates the heat toward the legs 121 of the occupant 12, as indicated by arrows ARt. In this way, areas of the legs 121, each of which is surrounded by a corresponding dot-dot-dash line, is particularly warmed. The first heater device 10a and the second heater device 10b both have an identical structure. Therefore, in the following description, only the first heater device 10a will be described.

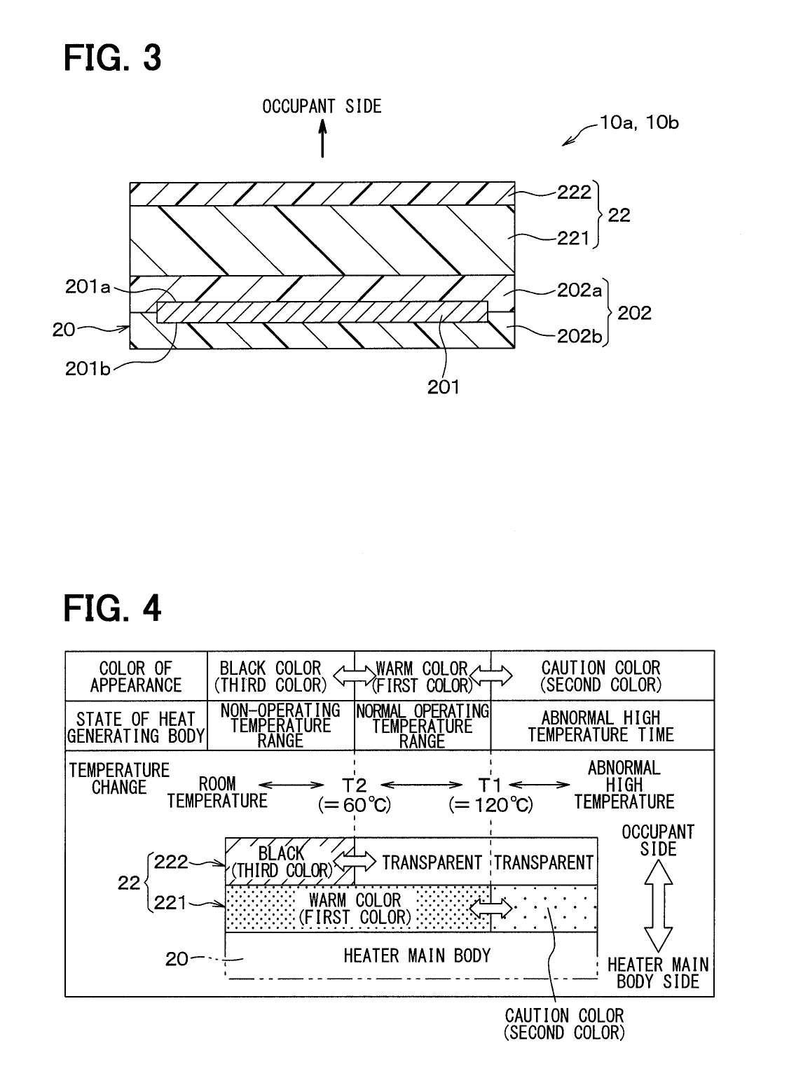

FIG. 2 is an exploded perspective view schematically showing a structure of the heater device 10a, 10b. Furthermore, FIG. 3 is a cross sectional view of the heater device 10a, 10b, which is cut in a thickness direction of the heater device 10a, 10b. As shown in FIGS. 2 and 3, the first heater device 10a is in a thin plate form, i.e., a flat form and is shaped into a rectangular form. That is, the first heater device 10a is a heater device that is flat.

The first heater device 10a includes a heater main body 20 and a surface layer portion 22. The heater main body 20 is a flat heater that is formed into a film form. Furthermore, as shown in FIG. 3, the heater main body 20 includes a heat generating body 201, which generates heat upon energization thereof, and a heat generating body substrate 202.

The heat generating body 201 is formed into a film form. One of two surfaces of the heat generating body 201, which are opposed to each other in the thickness direction of the heat generating body 201, i.e., a surface of the heat generating body 201 located on the occupant 12 side, forms a heating surface 201a of the heat generating body 201. Specifically, in the vehicle cabin shown in FIG. 1, the heating surface 201a faces the legs 121 of the occupant 12, and a back surface 201b (see FIG. 3) of the heat generating body 201, which is opposite from the heating surface 201a, faces the instrument panel 90.

For example, the heat generating body 201 is formed by a material that has an electrical resistance and is shaped into the film form. The heat generating body 201 radiates the heat of the heat generating body 201 from the heating surface 201a toward the occupant 12 who is a subject person to be heated. That is, the first heater device 10a is an on-vehicle radiant heater, which is flat and heats the occupant 12 in the vehicle cabin with the heat radiated from the heating surface 201a.

As shown in FIG. 3, the heat generating body substrate 202 covers the heating surface 201a and the back surface 201b of the heat generating body 201 and thereby receives the heat generating body substrate 202 in an inside of the heat generating body substrate 202. The heat generating body substrate 202 is made of a resin material, which has excellent dielectricity and high heat resistance. Specifically, the heat generating body substrate 202 includes a first substrate portion 202a and a second substrate portion 202b, which are respectively formed into a film form.

Although the first substrate portion 202a and the second substrate portion 202b are shaped into a rectangular form like the heat generating body 201, the first substrate portion 202a and the second substrate portion 202b project from the heat generating body 201 along the entire periphery of the heat generating body 201. The first substrate portion 202a is stacked over the heating surface 201a of the heat generating body 201, and the second substrate portion 202b is stacked over the back surface 201b of the heat generating body 201. Outer peripheral edge parts of the first substrate portion 202a and outer peripheral edge parts of the second substrate portion 202b are joined together, so that the heat generating body 201 is received in the inside of the heat generating body substrate 202.

An output, a temperature, and a calorific value of the heat generating body 201 of the heater main body 20 are controlled by a heater control device (not shown) that controls the first heater device 10a. The heater control device can control the output, the temperature and the calorific value of the heat generating body 201 by controlling a voltage value and a current value of the electric current applied to the heat generating body 201. Therefore, the amount of thermal radiation, which is radiated from the heat generating body 201 to the occupant 12 (see FIG. 1), is increased or decreased through the control operation of the heater control device. Specifically, the amount of thermal radiation, which is radiated from the first heater device 10a during the operation of the first heater device 10a, is adjusted by the heater control device such that the temperature of the heat generating body 201 is continuously kept within a normal operating temperature range (e.g., 60 to 120 degrees Celsius), which will be described later.

The surface layer portion 22 is stacked over the heating surface 201a of the heat generating body 201. Specifically, the surface layer portion 22 is stacked over the heating surface 201a through the first substrate portion 202a of the heat generating body substrate 202. Therefore, an opposite surface of the heater main body 20, which is opposite from the surface layer portion 22, serves as an installation surface that is installed to the instrument panel 90 (see FIG. 1).

The surface layer portion 22 coves an entire surface of the first substrate portion 202a and is joined to the first substrate portion 202a through, for example, bonding or adhering. Therefore, when the heat generating body 201 generates the heat, the surface layer portion 22 is heated by the heat generating body 201. In other words, the temperature of the surface layer portion 22 changes according to the temperature of the heat generating body 201. The surface layer portion 22 changes color according to the temperature of the surface layer portion 22.

In order to change the color of the surface layer portion 22 in response to the temperature in a manner discussed above, the surface layer portion 22 includes a first color variable layer 221 and a second color variable layer 222, as shown in FIGS. 2 and 3.

The first color variable layer 221 is stacked over the first substrate portion 202a of the heat generating body substrate 202 on the opposite side of the first substrate portion 202a, which is opposite from the heat generating body 201. The first color variable layer 221 is formed by, for example, an upholstery that is made of a resin woven fabric impregnated with, for example, thermal ink (a thermochromic material), which changes color at a predetermined temperature.

Thereby, the first color variable layer 221 changes color from a first color to a second color when the temperature of the first color variable layer 221 is increased beyond a first temperature threshold value T1. In other words, the thermochromic material, which is contained in the first color variable layer 221, changes color at the first temperature threshold value T1, which serves as a boundary.

Therefore, as shown in FIG. 4, at a temperature range, which is located on a low temperature side of the first temperature threshold value T1, the first color variable layer 221 has the first color that is a warm color, such as a red color or an orange color. In contrast, at a temperature range, which is located on a high temperature side of the first temperature threshold value T1, the first color variable layer 221 has the second color that is a caution color, such as a yellow color, which is predetermined and calls for caution. Specifically, the first color of the first color variable layer 221 is a color that has an emissivity, which is larger than an emissivity of the second color. The emissivity is a ratio of radiation energy of a substance relative to radiation energy of the blackbody at a constant temperature. FIG. 4 is a schematic diagram showing a relationship between the colors of the first and second color variable layers 221, 222 and the temperature of the surface layer portion 22.

As shown in FIGS. 2 and 3, the second color variable layer 222 is stacked over the first color variable layer 221 on an opposite side (i.e., the occupant 12 side) of the first color variable layer 221, which is opposite from the heat generating body 201. The second color variable layer 222 is a painted film (in other words, a paint coat) that is made of a paint applied to the first color variable layer 221. The second color variable layer 222 forms an outermost layer surface of the first heater device 10a on the occupant 12 side. Therefore, water-repellent finish is made at the second color variable layer 222. That is, the second color variable layer 222 has the water repellency.

Similar to the first color variable layer 221, the second color variable layer 222 is formed to have the thermochromic material, such as the thermal ink. In this way, when the temperature of the second color variable layer 222 is increased beyond a second temperature threshold value T2, which is predetermined, the second color variable layer 222 changes color from a third color to a transparent state, at which a visible light passes through the second color variable layer 222. In other words, the thermochromic material, which is contained in the second color variable layer 222, changes color at the second temperature threshold value T2, which serves as a boundary.

Therefore, as shown in FIG. 4, at a temperature range, which is located on a low temperature side of the second temperature threshold value T2, the color of the second color variable layer 222 becomes the third color that is a black color. In contrast, at a temperature range, which is located on a high temperature side of the second temperature threshold value T2, the second color variable layer 222 becomes the transparent state. The transparent state of the second color variable layer 222 refers to a colorless optically-transparent state or a colored optically-transparent state, at each of which rays of light penetrate through the second color variable layer 222. In the present embodiment, the second color variable layer 222 becomes the colorless optically-transparent state at the temperature range, which is located on the high temperature side described above. The colors of each of the color variable layers 221, 222 refer colors that include the transparent color(s) besides the opaque color(s), such as the orange color or the black color.

Specifically, the first temperature threshold value T1 is set to correspond to an upper limit temperature of the normal operating temperature range of the heat generating body 201, which is predetermined and is permitted at the time of continuously using the heat generating body 201. In the present embodiment, the first temperature threshold value T1 is set to be 120 degrees Celsius, as shown in FIG. 4. Furthermore, the second temperature threshold value T2 is a temperature threshold value, which is lower than the first temperature threshold value T1. The second temperature threshold value T2 is set to correspond to a lower limit temperature of the normal operating temperature range of the heat generating body 201. In the present embodiment, the second temperature threshold value T2 is set to be 60 degrees Celsius. The setting of the first temperature threshold value T1 to correspond to the upper limit temperature of the normal operating temperature range is not necessarily limited to coinciding of the first temperature threshold value T1 to the upper limit upper limit temperature but also includes generally coinciding of the first temperature threshold value T1 to the upper limit temperature in view of a technical common sense. This is also true with respect to the relationship between the second temperature threshold value T2 and the lower limit temperature of the normal operating temperature range.

As discussed above, the first color variable layer 221 changes color at the first temperature threshold value T1, which serves as the boundary, and the second color variable layer 222 changes color at the second temperature threshold value T2, which serves as the boundary. Each of the first color variable layer 221 and the second color variable layer 222 may instantaneously change color or may gradually change color through a color change transition state.

Although the occupant 12 side of the heater main body 20 is covered with the surface layer portion 22, it is conceivable that an object contacts the surface layer portion 22 during the operation of the first heater device 10a. In a case where the object contacts the surface layer portion 22, the heat, which is conducted from the heat generating body 201 to the surface layer portion 22, is rapidly conducted to and is diffused into the objection, which is in contact with the surface layer portion 22. Therefore, the temperature of the contact part of the surface layer portion 22, which is in contact with the object, is rapidly decreased. Therefore, the surface temperature of the contact part of the first heater device 10a, which is in contact with the object, is rapidly decreased. As discussed above, in the case where the object contacts the surface layer portion 22, the surface temperature of the contact part of the first heater device 10a, which is in contact with the object, is locally decreased, so that it is possible to avoid excess heating of the object, which is in contact with the surface layer portion 22.

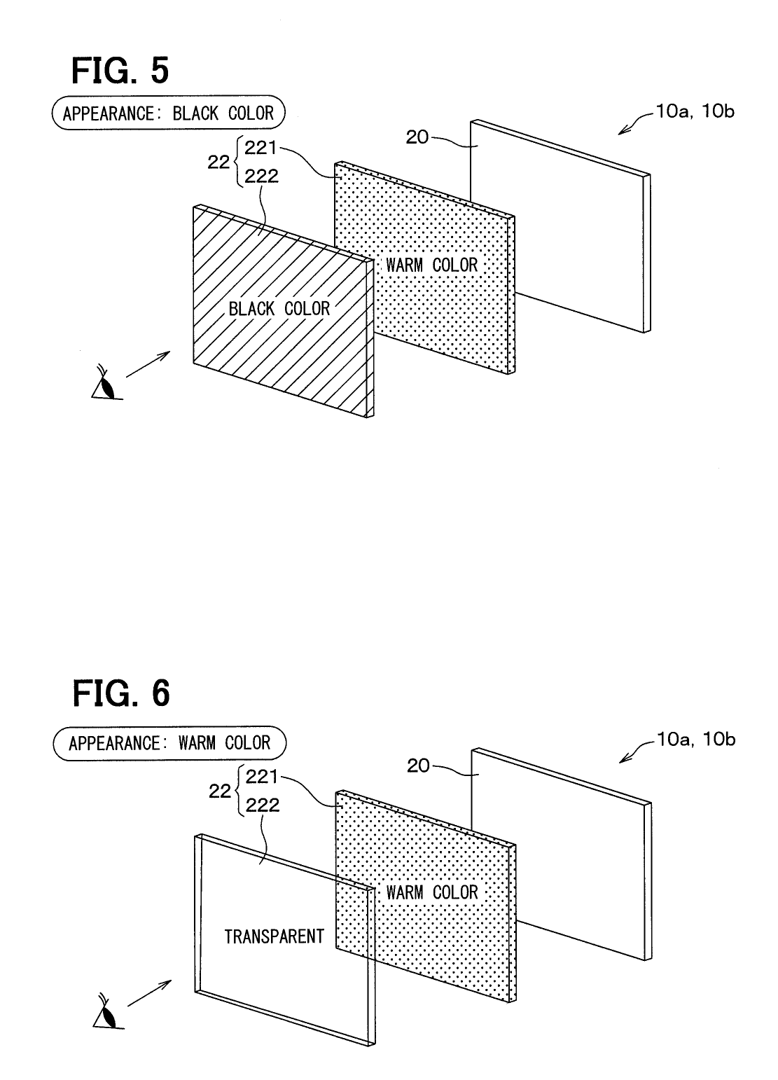

Next, the color change of the first heater device 10a will be described. FIG. 5 is an exploded perspective view of the heater device 10a, 10b, showing the colors of the surface layer portion 22 at the non-operating temperature range of the heat generating body 201, i.e., the non-operating temperature range of the heater device 10a, 10b. This non-operating temperature range is a temperature range that is lower than the lower limit temperature of the normal operating temperature range. At the non-operating temperature range, the heat generating body 201 is in a state where the heat generating body 201 is not operated and has the room temperature or a state where the heat generating body 201 is immediately after the operation thereof, so that the temperature of the heat generating body 201 is approaching to the lower limit temperature of the normal operating temperature range. In the present embodiment, the lower limit temperature of the normal operating temperature range is set to be 60 degrees Celsius.

As shown in FIGS. 5 and 4, at the non-operating temperature range of the heat generating body 201, the temperature of the second color variable layer 222 of the surface layer portion 22 is equal to or lower than the second temperature threshold value T2 (specifically equal to or lower than 60 degrees Celsius), and thereby the second color variable layer 222 is opaque and has the third color. Accordingly, the first heater device 10a appears to have the third color of the second color variable layer 222, that is, the black color, when the first heater device 10a is viewed from the occupant 12.

FIG. 6 is an exploded perspective view of the heater device 10a, 10b and shows the colors of the surface layer portion 22 at the normal operating temperature range (e.g., 60 to 120 degrees Celsius) of the heat generating body 201. As shown in FIGS. 6 and 4, at the normal operating temperature range of the heat generating body 201, the temperature of the first and second color variable layers 221, 222 of the surface layer portion 22 is higher than the second temperature threshold value T2 and is equal to or lower than the first temperature threshold value T1 (specifically, equal to or lower than 120 degrees Celsius). Therefore, the second color variable layer 222 becomes the transparent state, and the first color variable layer 221 has the first color. Thus, when the occupant 12 views the first heater device 10a, the second color variable layer 222 is transparent while the first color variable layer 221 is visible. As a result, for the occupant 12, the first heater device 10a appears to have the first color, i.e., the warm color (e.g., the orange color) of the first color variable layer 221.

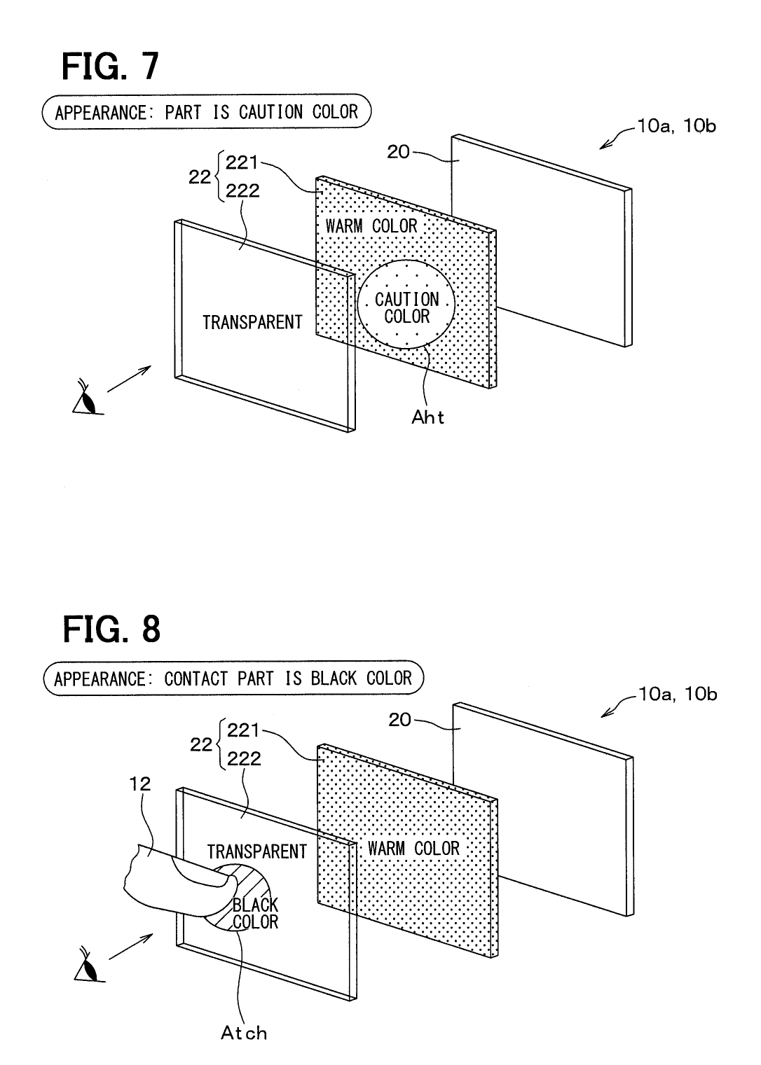

FIG. 7 is an exploded perspective view of the heater device 10a, 10b and shows colors of the surface layer portion 22 at a time of an abnormal high temperature (e.g., a high temperature that is higher than 120 degrees Celsius), at which the heat generating body 201 is partially overheated to the abnormal high temperature that is beyond the normal operating temperature range. In the example of FIG. 7, the heat generating body 201 partially has the abnormal high temperature.

At the time of the abnormal high temperature of the heat generating body 201 shown in FIG. 7, the temperature of the first and second color variable layers 221, 222 of the surface layer portion 22 is higher than the second temperature threshold value T2. The temperature of the first and second color variable layers 221, 222 exceeds the first temperature threshold value T1 at an abnormal high temperature portion Aht, which is a portion of the surface layer portion 22. However, at the rest of the surface layer portion 22, which is other than the abnormal high temperature portion Aht, the temperature is equal to or lower than the first temperature threshold value T1. Therefore, the second color variable layer 222 becomes the transparent state, and the first color variable layer 221 has the second color at the abnormal high temperature portion Aht while the first color variable layer 221 has the first color at the rest of the first color variable layer 221, which is other than the abnormal high temperature portion Aht. Thus, when the occupant 12 views the first heater device 10a, the second color variable layer 222 is transparent while the first color variable layer 221 is visible. That is, for the occupant 12, the first heater device 10a appears to have the second color, i.e., the caution color (e.g., the yellow color) of the first color variable layer 221 at the abnormal high temperature portion Aht and the first color, i.e., the warm color of the first color variable layer 221 at the rest of the first heater device 10a, which is other than the abnormal high temperature portion Aht.

FIG. 8 is an exploded perspective view of the heater device 10a, 10b and shows colors of the surface layer portion 22 in a case where the occupant 12 contacts an occupant side surface of the heater device when the temperature of the heat generating body 201 is in the normal operating temperature range. In the example of FIG. 8, the occupant 12 contacts a portion of the surface layer portion 22.

As shown in FIG. 8, when the occupant 12 contacts the first heater device 10a during the operation of the first heater device 10a, the temperature of the first heater device 10a is decreased at a contact part Atch of the first heater device 10a, which includes a portion of the first heater device 10a contacted by the occupant 12, and its peripheral area. Therefore, the temperature of the first and second color variable layers 221, 222 is higher than the second temperature threshold value T2 and is equal to or lower than the first temperature threshold value T1 at the rest of the surface layer portion 22, which is other than the contact part Atch, while the temperature of the first and second color variable layers 221, 222 is equal to or lower than the second temperature threshold value T2 at the contact part Atch.

Thus, when the occupant 12 views the first heater device 10a, the rest of the first heater device 10a, which is other than the contact part Atch, appears to have the first color of the first color variable layer 221 due to the transparency of the second color variable layer 222. In contrast, at the contact part Atch, since the second color variable layer 222 has the third color, the first color variable layer 221 cannot be viewed by the occupant 12. Thereby, the first heater device 10a appears to have the third color at the contact part Atch.

As discussed above with reference to FIGS. 4 to 8, the surface layer portion 22 changes color according to the temperature of the heat generating body 201. Here, the surface layer portion 22 changes color from one color to another color having a lower emissivity in comparison to the one color when the temperature of the heat generating body 201, i.e., the temperature of the surface layer portion 22 is increased. In general, it is known that the black color or dark color is a color that has a large emissivity (specifically, a color having an emissivity of about 0.9), and the white color or yellow color is a color that has a small emissivity (specifically, a color having an emissivity of about 0.7 to 0.8).

As discussed above, according to the present embodiment, the surface layer portion 22 is stacked over the heating surface 201a of the heat generating body 201 and is heated by the heat of the heat generating body 201, and the surface layer portion 22 changes color according to the temperature of the surface layer portion 22. Thus, it is possible to notify the temperature of the heater device 10a, 10b to the occupant 12 who is a subject person to be warmed with the heater device 10a, 10b based on the appearance of the heater device 10a, 10b.

Furthermore, according to the present embodiment, the first color variable layer 221, which forms the one layer of the surface layer portion 22, changes color from the first color to the second color when the temperature of the first color variable layer 221 is increased beyond the first temperature threshold value T1, as shown in FIG. 4. Thus, during the time of generating the heat from the heat generating body 201, it is possible to visually notify the occupant 12 about whether the temperature of the heat generating body 201 is increased beyond the first temperature threshold value T1.

Furthermore, according to the present embodiment, as shown in FIG. 3, the surface layer portion 22 is stacked over the heating surface 201a of the heat generating body 201 through the first substrate portion 202a of the heat generating body substrate 202. Therefore, while the heater main body 20 is used as a common component, it is possible to implement different types of heater devices 10a, 10b, each of which has a different color change pattern that is different from the color change pattern of any of the other heater devices 10a, 10b.

Furthermore, according to the present embodiment, as shown in FIG. 4, the first temperature threshold value T1 is set to correspond to the upper limit temperature of the heat generating body 201, which is predetermined and is permitted at the time of continuously using the heat generating body 201. Thus, it is possible to visually notify the occupant 12 whether the heat generating body temperature is the high temperature, which is beyond the upper limit temperature of the heat generating body, i.e., it is possible to visually notify the occupant 12 whether the heat generating body temperature is the high temperature, which is beyond the normal operating temperature range.

Furthermore, according to the present embodiment, the second temperature threshold value T2 is set to correspond to the lower limit temperature of the heat generating body 201, which is predetermined and is permitted at the time of continuously using the heat generating body 201. Therefore, it is possible to visually notify the non-operating state of the heater device 10a, 10b to the occupant 12.

Furthermore, according to the present embodiment, the first color of the first color variable layer 221 has the emissivity that is larger than the emissivity of the second color of the first color variable layer 221. Therefore, when the temperature of the first color variable layer 221 is increased, the color of the first color variable layer 221 becomes whiter. Thus, it is possible to set the color change of the first color variable layer 221, which corresponds to the temperature of the first color variable layer 221, to the one that is in conformity with the human senses.

Furthermore, according to the present embodiment, the second color variable layer 222 changes color from the third color to the transparent state when the temperature of the second color variable layer 222 is increased beyond the second temperature threshold value T2 that is lower than the first temperature threshold value T1. Therefore, the surface layer portion 22 can change color among the three colors while allowing visual recognition of the color change of the first color variable layer 221.

Furthermore, according to the present embodiment, the second color variable layer 222 has the water repellency, so that it is possible to limit occurrence of a problem caused by adhesion of water to the second color variable layer 222 at the time of occurrence of dew condensation at the heater device 10a, 10b.

As discussed above, the heater device 10a, 10b is constructed such that the color of appearance of the heater device 10a, 10b, which is viewed from the occupant 12, changes depending on the temperature change that is, for instance, described with reference to FIGS. 5 to 8. In this way, it is possible to notify the activation of the heater device 10a, 10b to the occupant 12 through the appearance of the heater device 10a, 10b. Also, it is possible to notify the operation of the heater device 10a, 10b, which is in the normal operating temperature range under the temperature control of the heater control device, to the occupant 12.

Additionally, for instance, in a case where a temperature of a portion of the heater main body 20 is increased to an abnormally high temperature due to a partial damage of the heater main body 20, or a case where the heat generating body 201 shows an abnormal temperature increase due to some abnormality at the temperature control of the heater control device, the color of appearance of the heater main body 20, which is viewed by the occupant 12, is changed to the caution color that calls for caution. In this way, the abnormality of the heater device 10a, 10b can be notified to the occupant 12 through the appearance of the heater device 10a, 10b. Thereby, it is possible to provide a sense of safety to the occupant 12.

Furthermore, the occupant 12 can visually recognize the characteristic of the heater device 10a, 10b, i.e., the occurrence of reducing of the temperature of the contact part Atch (see FIG. 8) by visually recognizing the change of the color of the contact part Atch to the black color caused by the temperature decrease. That is, the safety of the heater device 10a, 10b with respect to the contact to the heater device 10a, 10b can be visually notified to the occupant 12. In the heater device 10a, 10b of the present embodiment, the various advantages described above can be achieved by a simple structure of having the surface layer portion 22. Specifically, with the inexpensive and simple structure, it is possible to provide the occupant 12 the advantageous color change of the surface layer portion 22 to the color, which indicates the non-operating time of the heater main body 20, the color, which indicates the operating time of the heater main body 20, or the color, which indicates the abnormal high temperature of the heater main body 20. This advantageous color change of the surface layer portion 22 is implemented without using a complicated electronic device or an expensive light emitter. Furthermore, at the time of the abnormal high temperature of the heater main body 20, the occupant 12 is enabled to visually recognize the caution color, such as the yellow color, which has the small emissivity, so that occurrence of a thermal problem to the occupant 12 can be reduced.

### Second Embodiment

Next, a second embodiment will be described. In the present embodiment, differences, which are different from the first embodiment, will be mainly described, and the description of the portions, which are the same as or equivalent to those of the first embodiment, will be omitted or simplified.

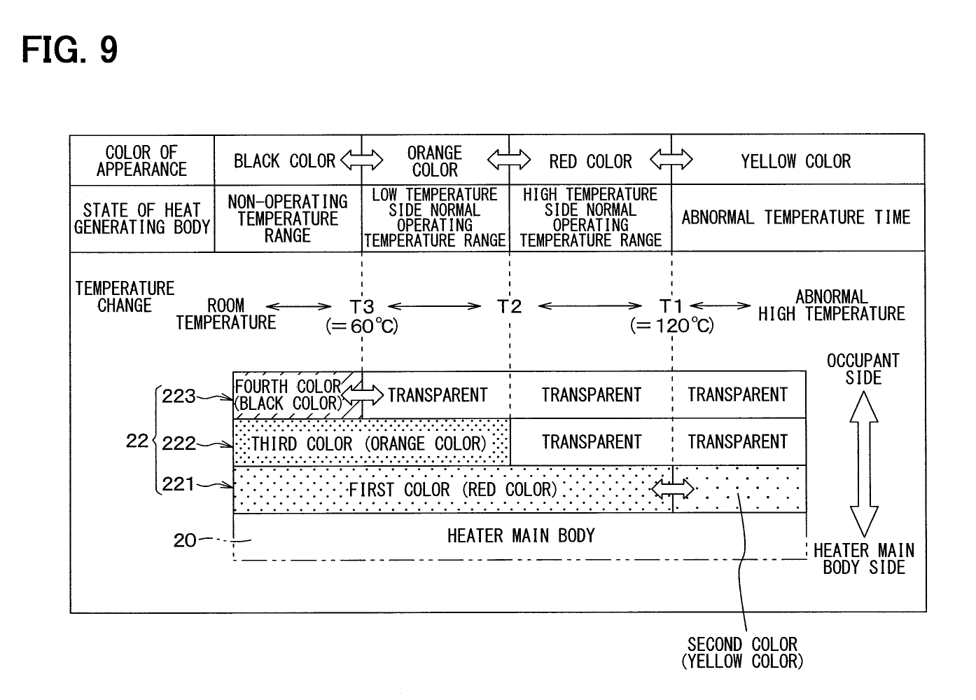

FIG. 9 is a schematic diagram, which corresponds to FIG. 4 and shows a relationship between a color(s) of each color variable layer 221, 222, 223 of the surface layer portion 22 and a temperature of the surface layer portion 22. As shown in FIG. 9, in the present embodiment, the surface layer portion 22 includes a third color variable layer 223 in addition to the first color variable layer 221 and the second color variable layer 222. Therefore, the outermost layer of the surface layer portion 22 on the occupant 12 side is the third color variable layer 223 rather than the second color variable layer 222. Furthermore, each of the color variable layers 221, 222, 223 is made of, for example, a thin fil that is in a form of a seal. The above points are different from the first embodiment.

Specifically, in the surface layer portion 22, the second color variable layer 222 is stacked over the first color variable layer 221 on the occupant 12 side, and the third color variable layer 223 is stacked over the second color variable layer 222 on the occupant 12, and these color variable layers 221, 222, 223 are integrated together.

In the present embodiment, the second color of the first color variable layer 221 is, for example, the yellow color that is the caution color like in the first embodiment. Furthermore, the first color of the first color variable layer 221 is the warm color like in the first embodiment but is the red color.

Although the third color of the second color variable layer 222 is the warm color, this third color of the second color variable layer 222 is a color that is different from the first color. The third color is, for example, the orange color. The second temperature threshold value T2 is an intermediate temperature that is intermediate between the upper limit temperature and the lower limit temperature of the normal operating temperature range. In the present embodiment, the upper limit temperature of the normal operating temperature range is 120 degrees Celsius, and the lower limit temperature of the normal operating temperature range is 60 degrees Celsius.

The third color variable layer 223 changes color from the fourth color to the transparent state when the temperature of the third color variable layer 223 is increased beyond a predetermined third temperature threshold value T3. That is, as shown in FIG. 9, at the temperature range, which is lower than the third temperature threshold value T3, the color of the third color variable layer 223 is the fourth color that is the black color. In contrast, at the temperature range, which is higher than the third temperature threshold value T3, the third color variable layer 223 is in the transparent state. The transparent state of the third color variable layer 223 may be the colored optically-transparent state or the colorless optically-transparent state. In this particular embodiment, the transparent state of the third color variable layer 223 is the colorless optically-transparent state.

Specifically, the third temperature threshold value T3 is a temperature threshold value that is lower than the second temperature threshold value T2 and is set to correspond to the lower limit temperature of the normal operating temperature range of the heat generating body 201 discussed above. In the present embodiment, the third temperature threshold value T3 is set to be 60 degrees Celsius.

Since the surface layer portion 22 has the above-described structure, the surface layer portion 22 changes color in a manner shown in FIG. 9 according to the temperature of the surface layer portion 22. Specifically, the color of appearance of the first heater device 10a viewed from the occupant 12 becomes the orange color, which is the third color, at the temperature range that is lower than the second temperature threshold value T2 in the normal operating temperature range of the heat generating body 201. At the temperature range, which is higher than the second temperature threshold value T2, in the normal operating temperature range, the color of appearance of the first heater device 10a becomes the red color that is the first color.

As discussed above, in the present embodiment, the surface layer portion 22 changes color in more various ways in the normal operating temperature range in comparison to the first embodiment. In this way, the temperature state of the heater device 10a, 10b can be visually notified to the occupant 12 with an increased accuracy.

Furthermore, according to the present embodiment, the advantages, which can be achieved with the common structure that is common to the first embodiment, can be achieved in a manner similar to the first embodiment.

Furthermore, in the present embodiment, since the outermost layer of the surface layer portion 22 on the occupant 12 side is the third color variable layer 223, it is desirable to apply the water-repellent finish at the third color variable layer 223 rather than the second color variable layer 222.

### Other Embodiments

(1) In each of the above embodiments, the heater device 10a, 10b is the on-vehicle radiant heater, which is installed to the vehicle. However, the installation location of the heater device 10a, 10b is not necessarily limited to the vehicle. For example, the heater device 10a, 10b may be installed at an inside of a room of a building or the like.

(2) In each of the above embodiments, the surface layer portion 22 covers the entire surface of the first substrate portion 202a of the heat generating body substrate 202. Alternatively, the surface layer portion 22 may only partially cover the first substrate portion 202a.

(3) In the first embodiment, the third color of the second color variable layer 222 is the black color. However, the third color of the second color variable layer 222 is not necessarily limited to the black color. That is, as long as the third color is different from the first color and the second color of the first color variable layer 221, the third color may be another color. For example, the third color of the second color variable layer 222 may be an interior color, which is the same color as a color of the instrument panel 90 serving as an interior member provided with the first heater device 10a, or a color that is similar to the interior color. Also, the first color and the second color of the first color variable layer 221 may be freely selected.

For example, the third color of the second color variable layer 222, which indicates the heat generating body temperature at the non-operating temperature range, may be the interior color. Additionally, the first color of the first color variable layer 221, which indicates the heat generating body temperature at the normal operating temperature range, may be the black color or a dark red color, and the second color of the first color variable layer 221, which indicates the heat generating body temperature at the time of the abnormal high temperature, may be the white color or the yellow color, which has the emissivity that is smaller than the emissivity of the black color and the emissivity of the dark red color.

Furthermore, similar to this, in the second embodiment, the fourth color of the third color variable layer 223 may be the interior color or the color similar to the interior color in place of the black color.

(4) In the first embodiment, the surface layer portion 22 includes the first color variable layer 221 and the second color variable layer 222. Alternatively, it is conceivable that the surface layer portion 22 does not include the second color variable layer 222. That is, it is only required that the surface layer portion 22 includes at least one color variable layer.

For example, in a case where among the two color variable layers 221, 222, the surface layer portion 22 includes only the first color variable layer 221 without the second color variable layer 222, the advantage of the color change of the surface layer portion 22 may be limited to the advantage of that the color of the surface layer portion 22 is changed to the caution color only at the time of the abnormal high temperature of the heat generating body 201.

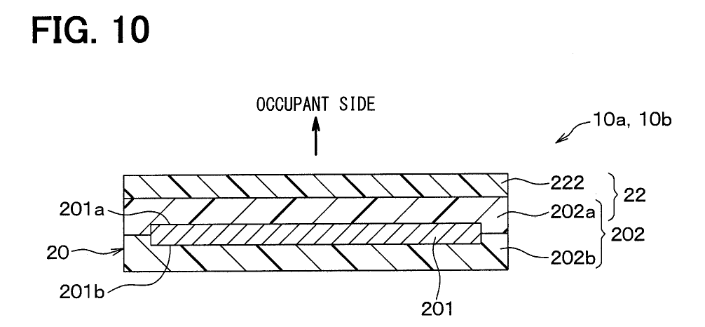

In the first embodiment, alternatively, it is conceivable that the surface layer portion 22 includes the second color variable layer 222 without the first color variable layer 221, as shown in FIG. 10. In such a case, for example, the whole of the heat generating body substrate 202 or the first substrate portion 202a of the heat generating body substrate 202 may be colored to the warm color, such as the orange color. That is, as shown in FIG. 10, the first substrate portion 202a forms the portion of the surface layer portion 22 and serves as a colored layer that has the first color, and the first substrate portion 202a becomes a portion that overlaps with the heater main body 20 and the surface layer portion 22.

When the temperature of the second color variable layer 222 is increased beyond the second temperature threshold value T2, the second color variable layer 222 changes color to the transparent state. Thereby, at this time, the warm color of the heat generating body substrate 202 is viewed through the second color variable layer 222 that is transparent. That is, the operational state of the heater main body 20 can be indicated by the color change. The advantage of the color change of the second color variable layer 222 to the black color at the contact part Atch (see FIG. 8) can be achieved without the first color variable layer 221.

(5) In each of the above embodiments, each color variable layer 221, 222, 223 exhibits the color change phenomenon according to the temperature by including, for example, the thermal ink. However, this is the mere example. For example, in place of the thermal ink, each color variable layer 221, 222, 223 may be formed with a material, a substance, a close or the like, which changes color according the temperature, to exhibit the color change phenomenon according to the temperature.

(6) In each of the above embodiments, the first color variable layer 221 is made of the upholstery that is impregnated with, for example, the thermal ink, so that the first color variable layer 221 is a different member that is different from the heat generating body substrate 202. However, the first color variable layer 221 may form at least a portion of the heat generating body substrate 202. In such a case, for example, the first substrate portion 202a of the heat generating body substrate 202 is made of a thin film that includes the thermal ink. The first substrate portion 202a serves as the first color variable layer 221 and forms a portion of the surface layer portion 22, and the first substrate portion 202a becomes the portion that overlaps with the heater main body 20 and the surface layer portion 22.

(7) In the first embodiment, the second color variable layer 222 forms the outermost layer of the surface layer portion 22 and has the water repellency. Alternatively, the water-repellent finish may not be applied to the second color variable layer 222, and the second color variable layer 222 may be formed by the paint coat that is simply made of the thermal ink. This is also true for the third color variable layer 223 of the second embodiment.

(8) In the first embodiment, the second color variable layer 222 is the painted film made of the paint, which is applied to the first color variable layer 221. For example, the second color variable layer 222 may be made of a film that is bonded to the first color variable layer 221. In such a case, a thin film, which is in a form of a seal printed with the thermal ink, becomes the second color variable layer 222, and this second color variable layer 222, which is the thin film, is bonded to the first color variable layer 221.

(9) In each of the above embodiments, although it is not necessary to place an illumination around the heater device 10a, 10b, a simple light emitter, such as an LED or a light bulb, may be placed around the heater device 10a, 10b. With this construction, in a case of, for example, a night where it is difficult to visually recognize the color change of the surface of the heater device 10a, 10b, the surface of the heater device 10a, 10b is illuminated with the light emitter, and thereby, the occupant 12 can easily recognize the color change of the heater device 10a, 10b.

The present disclosure should not be limited to the above embodiments. The present disclosure covers various modifications and changes within a scope of the equivalence. Furthermore, in each of the above embodiments, some components of the embodiment may be eliminated unless the components are expressly indicated as indispensable components or are obviously considered as indispensable components in view of the principle of the present disclosure. Furthermore, in each of the above embodiments, in the case where the number of the component(s), the value, the amount, the range, or the like is specified, the present disclosure is not limited to the number of the component(s), the value, the amount, or the like specified in the embodiment unless the number of the component(s), the value, the amount, or the like is indicated as indispensable or is obviously indispensable in view of the principle of the present disclosure. Furthermore, in each of the above embodiments, in the case where the material of the component(s), the shape of the component(s), the positional relationship of the component(s), or the like is specified, the present disclosure is not limited to the material of the component(s), the shape of the component(s), the positional relationship of the component(s), or the like unless the embodiment specifically states that the material of the component(s), the shape of the component(s), the positional relationship of the component(s), or the like is necessary, or the embodiment states that the present disclosure is limited in principle to the material of the component(s), the shape of the component(s), the positional relationship of the component(s), or the like discussed above.

What is claimed is:

1.-13. (canceled)

14. A heater device comprising:
a heat generating body that includes a heating surface and radiates heat from the heating surface; and
a surface layer portion that is stacked over the heating surface and is to be heated by the heat generating body, wherein:
the surface layer portion changes color depending on a temperature of the surface layer portion;
the surface layer portion includes a first color variable layer;
the first color variable layer changes color from a first color to a second color when a temperature of the first color variable layer is increased beyond a first temperature threshold value that is predetermined; and
the first color is a color that has an emissivity, which is larger than an emissivity of the second color.

15. The heater device according to claim 14, wherein:
the surface layer portion includes a second color variable layer that is stacked over the first color variable layer on an opposite side of the first color variable layer, which is opposite from the heat generating body; and
the second color variable layer changes color from a third color to a transparent state, at which a visible light passes through the second color variable layer, when a temperature of the second color variable layer is increased beyond a second temperature threshold value that is predetermined and is lower than the first temperature threshold value.

16. The heater device according to claim 15, wherein the second color variable layer is formed by a paint coat that is made of a paint, which is coated to the first color variable layer.

17. The heater device according to claim 15, wherein the second color variable layer is formed by a film that is bonded to the first color variable layer.

18. The heater device according to claim 15, wherein the second color variable layer has water repellency.

19. The heater device according to claim 15, wherein the second temperature threshold value is set to correspond to a lower limit temperature of the heat generating body that is predetermined and is permitted at a time of continuously using the heat generating body.

20. The heater device according to claim 14, wherein the first color variable layer forms at least a portion of a heat generating body substrate that covers the heat generating body.

21. The heater device according to claim 14, comprising a heat generating body substrate that covers the heat generating body, wherein the surface layer portion is stacked over the heating surface through the heat generating body substrate.

22. The heater device according to claim 14, wherein the first temperature threshold value is set to correspond to an upper limit temperature of the heat generating body, which is predetermined and is permitted at a time of continuously using the heat generating body.

23. The heater device according to claim 14, wherein the heater device is an on-vehicle radiant heater that is flat and warms an occupant in an inside of a vehicle cabin with the heat radiated from the heating surface.

24. A heater device comprising:
a heat generating body that includes a heating surface and radiates heat from the heating surface; and
a surface layer portion that is stacked over the heating surface and is to be heated by the heat generating body, wherein:
the surface layer portion changes color depending on a temperature of the surface layer portion;
the surface layer portion includes a first color variable layer and a second color variable layer while the second color variable layer is stacked over the first color variable layer on an opposite side of the first color variable layer, which is opposite from the heat generating body;
the first color variable layer changes color from a first color to a second color when a temperature of the first color variable layer is increased beyond a first temperature threshold value that is predetermined; and
the second color variable layer changes color from a third color to a transparent state, at which a visible light passes through the second color variable layer, when a temperature of the second color variable layer is increased beyond a second temperature threshold value that is predetermined and is lower than the first temperature threshold value.

25. The heater device according to claim 24, wherein the second color variable layer is formed by a paint coat that is made of a paint, which is coated to the first color variable layer.

26. The heater device according to claim 24, wherein the second color variable layer is formed by a film that is bonded to the first color variable layer.

27. The heater device according to claim 24, wherein the second color variable layer has water repellency.

28. The heater device according to claim 24, wherein the second temperature threshold value is set to correspond to a lower limit temperature of the heat generating body that is predetermined and is permitted at a time of continuously using the heat generating body.

29. The heater device according to claim 24, wherein the first color variable layer forms at least a portion of a heat generating body substrate that covers the heat generating body.

30. The heater device according to claim 24, comprising a heat generating body substrate that covers the heat generating body, wherein the surface layer portion is stacked over the heating surface through the heat generating body substrate.

31. The heater device according to claim 24, wherein the first temperature threshold value is set to correspond to an upper limit temperature of the heat generating body, which is predetermined and is permitted at a time of continuously using the heat generating body.

32. The heater device according to claim 24, wherein the heater device is an on-vehicle radiant heater that is flat and warms an occupant in an inside of a vehicle cabin with the heat radiated from the heating surface.

33. A heater device comprising:
a heat generating body that includes a heating surface and radiates heat from the heating surface; and
a surface layer portion that is stacked over the heating surface and is to be heated by the heat generating body, wherein:
the surface layer portion changes color depending on a temperature of the surface layer portion;
the surface layer portion includes a colored layer, which has a first color, and a second color variable layer, which is stacked over the colored layer on an opposite side of the colored layer that is opposite from the heat generating body; and
the second color variable layer changes color from a third color to a transparent state, at which a visible light passes through the second color variable layer, when a temperature of the second color variable layer is increased beyond a second temperature threshold value that is predetermined.

34. The heater device according to claim 33, wherein the second color variable layer has water repellency.

35. The heater device according to claim 33, wherein the second temperature threshold value is set to correspond to a lower limit temperature of the heat generating body that is predetermined and is permitted at a time of continuously using the heat generating body.

36. The heater device according to claim 33, wherein the heater device is an on-vehicle radiant heater that is flat and warms an occupant in an inside of a vehicle cabin with the heat radiated from the heating surface.
